(19) United States
(12) Patent Application Publication
(10) Pub. No.: US 2025/0271256 A1
(43) Pub. Date: Aug. 28, 2025

(54) Laser Alignment Tool

(71) Applicant: Edward Hart, Flanders, NJ (US)

(72) Inventor: Edward Hart, Flanders, NJ (US)

(21) Appl. No.: 19/061,707

(22) Filed: Feb. 24, 2025

Related U.S. Application Data
(60) Provisional application No. 63/556,719, filed on Feb. 22, 2024.

(51) Int. Cl. G01B 11/27; B41F 15/14

(52) U.S. Cl. CPC G01B 11/27; B41F 15/14

(57) ABSTRACT

A laser alignment tool is a device that facilitates the efficient and accurate alignment of a product for different manufacturing processes such as Direct-to-Film, screen printing, embroidery, etc. The device includes a tool base, at least one laser module, a controller, and a portable power source. The tool base corresponds to the portion of the device that supports the operation of the at least one laser module. The tool base also facilitates the attachment of the device to a surface adjacent to the product that needs to be aligned. The at least one laser module emits one or more light beams on the adjacent surface that can be used to align the desired product. The controller enables the user to selective control the operation of the at least one laser module. The portable power source provides the electrical power necessary for the operation of the at least one laser module.

The current application claims a priority to the U.S. provisional patent application Ser. No. 63/556,719 filed on Feb. 22, 2024. The current application is filed on Feb. 24, 2025, while Feb. 22, 2025, was on a weekend.

### FIELD OF THE INVENTION

The present invention relates generally to laser devices and alignment systems. More specifically, the present invention discloses an alignment system that utilizes lasers to properly align an object on the target surface.

### BACKGROUND OF THE INVENTION

Direct-to-Film (DTF), screen printing, and embroidery often require the product that serves as the canvas to be properly aligned so whatever design is printed or embroidered on the product is properly oriented. The alignment process can be tricky and time consuming, so different tools have been made available to streamline the process. For example, many screen-printing machines provide an alignment tool that helps the user to properly align the product on the corresponding machine. However, these alignment tools are often part of the larger machine, which prevent these tools from being used with other devices, such as Do-It-Yourself (DIY) devices. To help users who may not have access to these machines, some alignment tools are available that allow manual alignment of the products, such as alignment rulers. However, many of these tools provide limited functionality as many of the devices require the use of markers and other accessories that make the process more complicated.

Therefore, the objective of the present invention is to provide a laser alignment tool that is designed for DTF, screen printing, and embroidery. The present invention eliminates the use of marking devices and other accessories to simplify the alignment of products. Another objective of the present invention is to provide a laser alignment tool that helps the user to save time and enable a higher degree of accuracy when aligning T-shirts, garments, or textiles to a screen-printing pallet or embroidery machine. In addition, the present invention can be used for other applications where solid products require alignment, such as woodworking, marble counter manufacturing, construction, etc. Additional features and benefits of the present invention are further discussed in the sections below.

### SUMMARY OF THE INVENTION

The present invention discloses a laser alignment tool. The laser alignment tool of the present invention includes one or more laser modules that can be oriented in the desired direction to emit light beams in different colors and patterns which help the user align the desired product. The laser modules of the present invention can output light beams in a line pattern, cross pattern, single point, circle pattern, or arc pattern. In addition, each of the laser modules can output light in multiple colors to help the user align the product properly. Further, the laser alignment tool includes a base that can be easily mounted onto different surfaces adjacent to the product being aligned. The tool base of the present invention can be equipped with magnets that allows the laser alignment tool to be mounted onto a metal surface.

Furthermore, the laser alignment tool of the present invention can be provided in different versions to help accommodate different alignment needs. In the preferred embodiment, the laser alignment tool can be provided with one or more laser modules connected to the tool base in a fixed manner that allows adjustment to the orientation of the emitted light beams. In an alternate embodiment, the laser alignment tool can be provided with one or more laser modules that can be removably attached to the tool base. Each laser module can still be adjusted to change the orientation of the desired laser device. Further, the removable design of the laser modules enables the user to swap any laser module for another that emits a different light color and/or pattern. In addition, each laser module can be arranged to be selectively activated from the tool base, emit light beams in a different color and/or pattern, etc.

### BRIEF DESCRIPTION OF THE DRAWINGS

FIG. 1 is a top-front-left perspective view of the present invention, wherein the present invention is shown with a single laser module.

FIG. 2 is a bottom-rear-right perspective view thereof.

FIG. 3 is a front view thereof.

FIG. 4 is a magnified cross-sectional view taken along line 4-4 in FIG. 3.

FIG. 5 is a top-front-left perspective view of the present invention, wherein the present invention is shown with a pair of laser modules.

FIG. 6 is a bottom-rear-right perspective view thereof.

FIG. 7 is a top-front-left perspective view of the present invention, wherein the present invention is shown without an orienting ball.

FIG. 8 is a top view thereof.

FIG. 9 is a magnified cross-sectional view taken along line 9-9 in FIG. 8.

FIG. 10 is a top-front-left perspective view of the present invention, wherein the present invention is shown with three laser modules.

FIG. 11 is a bottom-rear-right perspective view thereof.

FIG. 12 is a top-front-left perspective view of the present invention, wherein the present invention is shown with four laser modules.

FIG. 13 is a bottom-rear-right perspective view thereof.

FIG. 14 is a top-front-left perspective view of the present invention, wherein the present invention is shown with a single laser module, and wherein the adjustment tool is shown detached from the focus-adjustment ring.

FIG. 15 is a top-front-left perspective view thereof, wherein the adjustment tool is shown attached to the focus-adjustment ring.

FIG. 16 is a top-front-left exploded perspective view of an alternate embodiment of the present invention, wherein the alternate embodiment of the present invention is shown with a pair of removable laser modules.

FIG. 17 is a bottom-rear-right exploded perspective view thereof.

FIG. 18 is a top-front-left perspective view thereof, wherein the pair of removable laser modules is shown attached to the tool base.

FIG. 19 is a top-front-left perspective view of the tool base of the alternate embodiment of the present invention, wherein a pair of sockets covers is shown.

FIG. 20 is a block diagram illustrating the electrical connections and the electronic connections of the present invention, wherein the electrical connections are shown in solid lines, and wherein the electronic connections are shown in dashed lines.

FIG. 21 is a box diagram illustrating the electrical connections and the electronic connections of the alternate embodiment of the present invention, wherein the electrical connections are shown in solid lines, and wherein the electronic connections are shown in dashed lines.

### DETAILED DESCRIPTION OF THE INVENTION

All illustrations of the drawings are for the purpose of describing selected versions of the present invention and are not intended to limit the scope of the present invention.

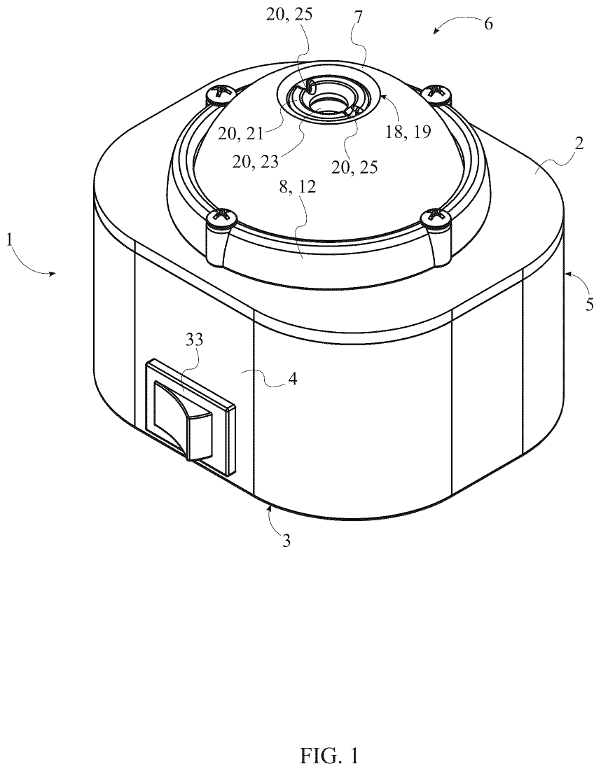

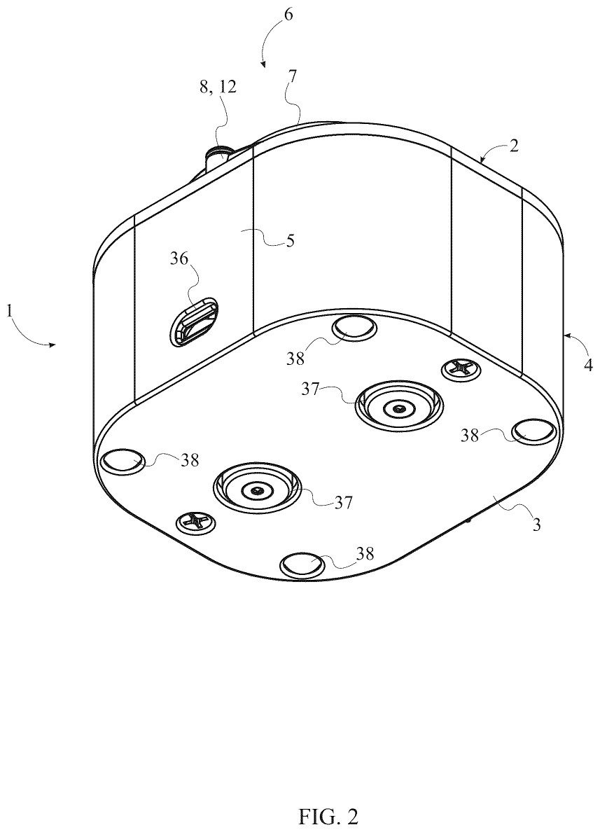

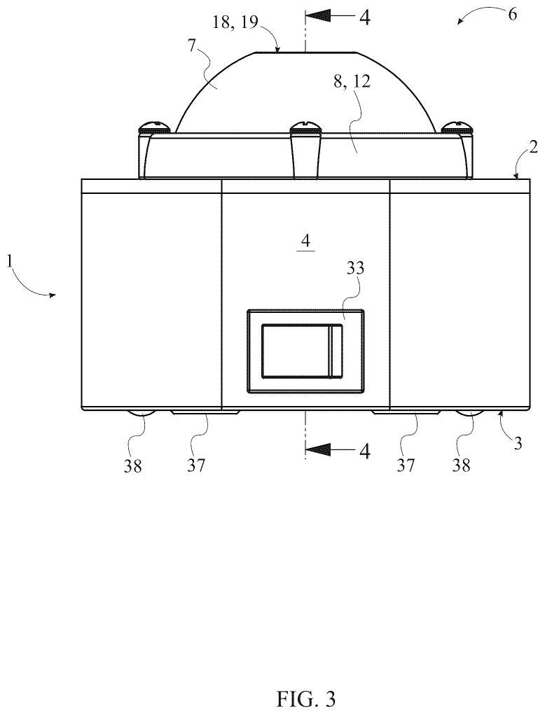

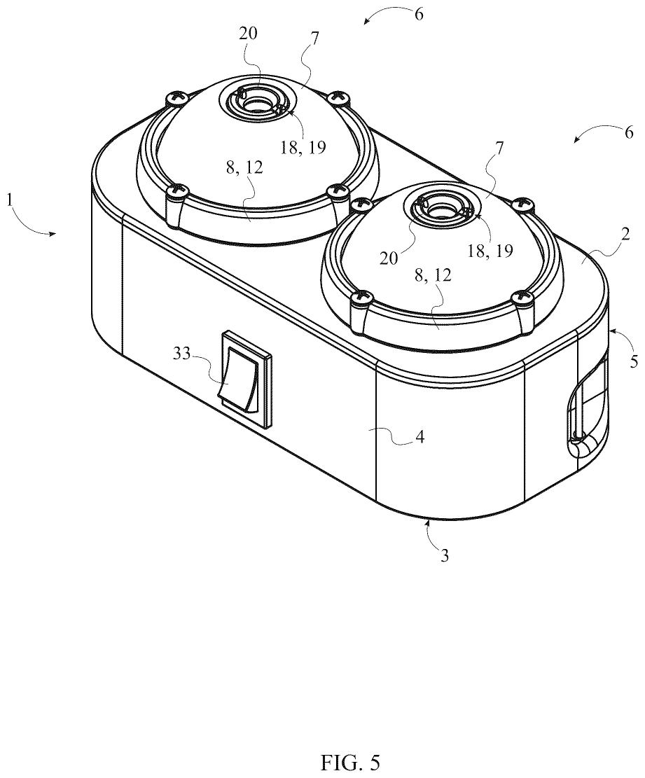

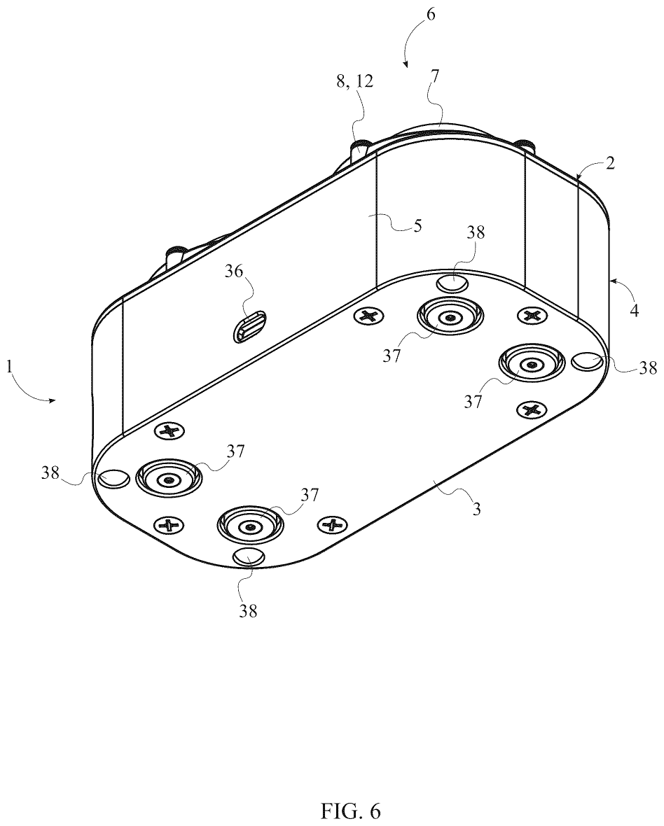

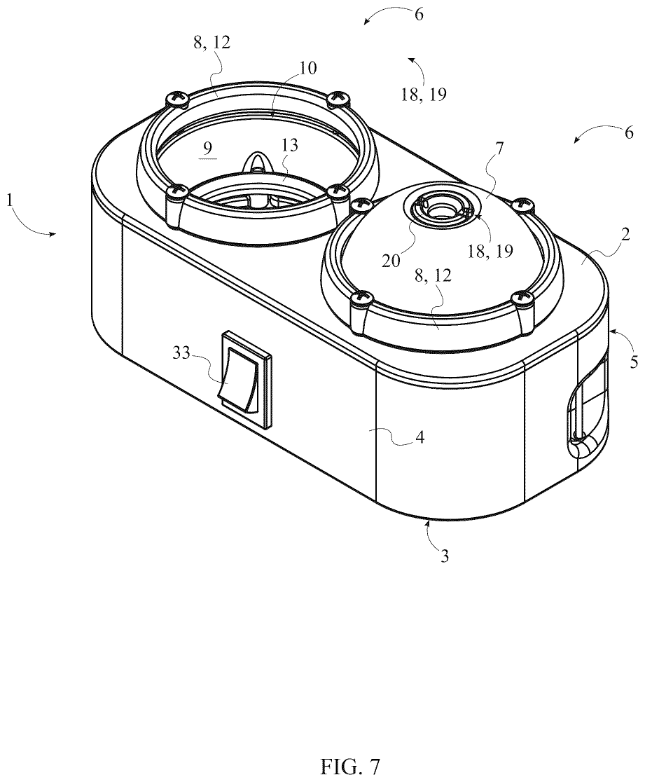

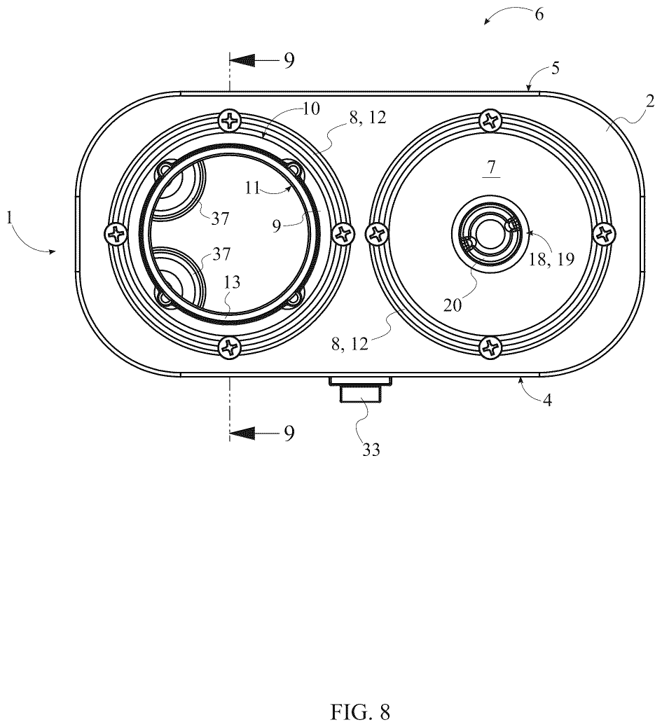

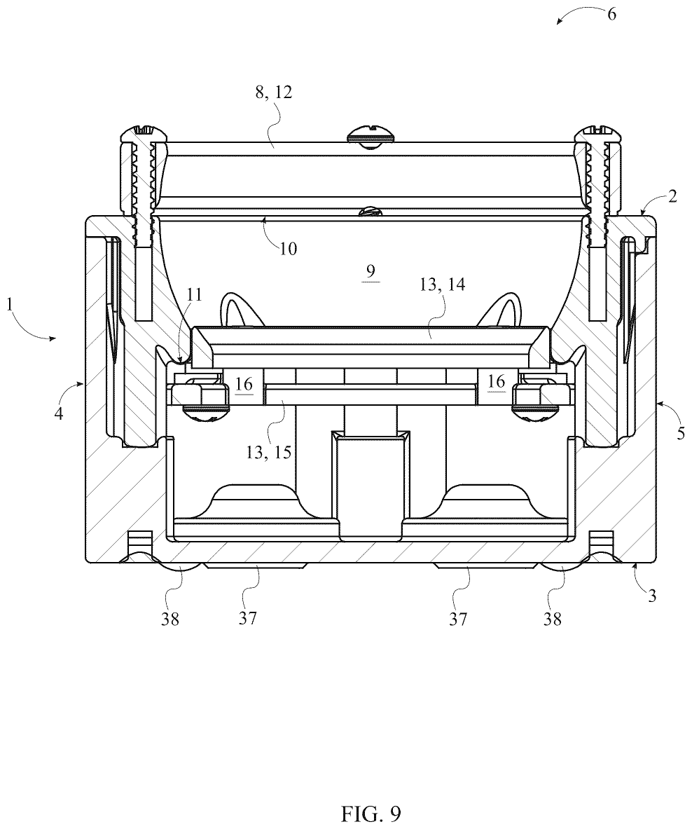

The present invention discloses a laser alignment tool that facilitates the alignment of a product more efficiently and accurately for different manufacturing processes including, but not limited to, Direct-to-Film (DTF), screen printing, embroidery, etc. As can be seen in FIGS. 1 through 9 and 20, the present invention comprises a tool base 1, at least one laser module 6, a controller 34, and a portable power source 35. The tool base 1 corresponds to the portion of the present invention that supports the at least one laser module 6. The tool base 1 also facilitates the attachment of the present invention to a surface adjacent to the product that needs to be aligned. The at least one laser module 6 emits one or more light beams on the adjacent surface that can be used to align the desired product. The controller 34 facilitates the selective control of the operation of the at least one laser module 6. The portable power source 35 provides the electrical power necessary for the operation of the present invention.

The overall configuration of the aforementioned components enables users to more efficiently and accurately align a product for different manufacturing processes. In general, the present invention is designed as a portable device that can be easily handled and comfortably carried by the user. As can be seen in FIGS. 1 through 9, the tool base 1 is designed as an overall rectangular structure with rounded ends with a size large enough to be operated using a single hand. So, the tool base 1 generally comprises a top base face 2 and a bottom base face 3 corresponding to the largest opposite surfaces of the tool base 1. Further, the at least one laser module 6 is preferably designed as a rotatable structure that can be rotated to reorient the emitted light beams.

In general, the at least one laser module 6 comprises an orienting ball 7, a socket setting 8, a diode channel 18, a focusing mechanism 20, and a laser diode 26, as can be seen in FIGS. 1 through 9 and 20. The orienting ball 7 corresponds to the rotatable structure of the at least one laser module 6 that can be manually rotated by the user. The socket setting 8 corresponds to the structure that facilitates the attachment of the at least one laser module 6 to the tool base 1. The socket setting 8 can be provided in different configurations that allow the at least one laser module 6 to be connected to the tool base 1 in a fixed manner or to be removably attached to the tool base 1. The diode channel 18 corresponds to the portion of the orienting ball 7 that accommodates the laser diode 26. The laser diode 26 corresponds to the mechanism of the at least one laser module 6 that emits the light beams, while the focusing mechanism 20 allows the configuration of the light beams emitted by the laser diode 26. Furthermore, the diode channel 18 comprises a distal open channel end 19 corresponding to an opening formed by the diode channel 18 on the orienting ball 7.

In the preferred embodiment, the present invention can be arranged as follows: the at least one laser module 6 is positioned adjacent to the top base face 2 to free the bottom base face 3, as can be seen in FIGS. 1 through 9 and 20. This allows the bottom base face 3 to engage with the desired surface which the tool base 1 is mounted onto. Further, the orienting ball 7 is pivotably mounted to the tool base 1 by the socket setting 8 so that the orienting ball 7 is secured to the tool base 1 while enabling the orienting ball 7 to rotate within the socket setting 8. In addition, the diode channel 18 diametrically traverses through the orienting ball 7 to form a cylindrical channel along the center of the orienting ball 7. Further, the distal open channel end 19 is located external to the tool base 1 and the socket setting 8 to position the distal open channel end 19 outside the socket setting 8. The focusing mechanism 20 is mounted into the distal open channel end 19 to configure the light beams emitted by the laser diode 26 which is mounted within the diode channel 18.

As can be seen in FIGS. 1 through 9, the laser diode 26 is in optical communication with the focusing mechanism 20 (i.e., the emitted light beams pass through the focusing mechanism 20 when exiting through the distal open channel end 19. This way, the user can manually engage the focusing mechanism 20 to alter the light beams emitted by the laser diode 26. Further, the controller 34 and the portable power source 35 are mounted within the tool base 1 so that the tool base 1 protects the controller 34 and the portable power source 35 from the surroundings. The laser diode 26 is electronically connected to the controller 34 so that the operation of the laser diode 26 is managed by the controller 34. Furthermore, the laser diode 26 and the controller 34 are electrically connected to the portable power source 35 to enable the transmission of the necessary electrical power to the laser diode 26 and the controller 34.

As previously discussed, the socket setting 8 of the present invention can be provided in a configuration where the at least one laser module 6 is connected to the tool base 1 in a fixed manner. As can be seen in FIGS. 1 through 9, in the fixed embodiment, the socket setting 8 may comprise a hemispherical socket 9 and a retainer ring 12. The hemispherical socket 9 is preferably formed on the tool base 1 to receive the orienting ball 7 of the at least one laser module 6. The retainer ring 12 is a structure designed to secure the orienting ball 7 inside the hemispherical socket 9 without obstructing the rotation of the orienting ball 7. Further, the hemispherical socket 9 comprises a diametric socket opening 10 corresponding to a hole in the tool base 1 that enables the insertion of the orienting ball 7 into the hemispherical socket 9.

In the preferred embodiment, the hemispherical socket 9 and the retainer ring 12 can be implemented as follows: the hemispherical socket 9 is integrated into the tool base 1 to form the necessary hemispherical space to receive the orienting ball 7, as can be seen in FIGS. 1 through 9. The diametric socket opening 10 is positioned coincident with the top base face 2 so that the orienting ball 7 protrudes past the top base face 2. Further, the retainer ring 12 is connected onto the hemispherical socket 9 and around the diametric socket opening 10 to secure the orienting ball 7 to the hemispherical socket 9. The orienting ball 7 has an outer diameter that is smaller than the inner diameter of the hemispherical socket 9 and the retainer ring 12. This way, the orienting ball 7 is rollably mounted in between the hemispherical socket 9 and the retainer ring 12. In other embodiments, different mechanisms can be implemented that secures the at least one laser module 6 to the tool base 1 while enabling the rotation of the orienting ball 7 on the tool base 1.

Due to the smaller diameter of the orienting ball 7, the orienting ball 7 may accidentally move inside the hemispherical socket 9. As can be seen in FIGS. 1 through 9, to help maintain the desired orientation of the orienting ball 7 inside the hemispherical socket 9, the socket setting 8 may further comprise a spring-loaded annulus 13. The spring-loaded annulus 13 is designed to push the orienting ball 7 against the retainer ring 12 to lock the desired orientation of the orienting ball 7 due to friction. In addition, the hemispherical socket 9 may further comprise a cap socket opening 11 that accommodates the spring-loaded annulus 13.

As can be seen in FIGS. 1 through 9, to integrate the spring-loaded annulus 13, the diametric socket opening 10 and the cap socket opening 11 are positioned opposite to each other about the hemispherical socket 9. In other words, the diametric socket opening 10 is positioned external to the hemispherical socket 9, while the cap socket opening 11 is positioned internal to the hemispherical socket 9. Further, the cap socket opening 11 is positioned within the tool base 1 so that the cap socket opening 11 is not visible when the orienting ball 7 is inserted into the hemispherical socket 9. In addition, the spring-loaded annulus 13 is mounted onto the hemispherical socket 9 and around the cap socket opening 11 to secure the spring-loaded annulus 13 to the hemispherical socket 9. Further, the orienting ball 7 is pressed against the spring-loaded annulus 13 when the orienting ball 7 is inserted into the hemispherical socket 9. This whey, the orienting ball 7 is inserted into the hemispherical socket 9 and the retainer ring 12 is fastened to the tool base 1, the orienting ball 7 is pushed up against the retainer ring 12 by the spring-loaded annulus 13. If the user wants to reorient the at least one laser module 6, the user pushes the orienting ball 7 into the hemispherical socket 9 against the spring-loaded annulus 13. This releases the friction between the orienting ball 7 and the retainer ring 12 which allows the user to freely rotate the orienting ball 7.

Different mechanisms can be implemented for the spring-loaded annulus 13. In the preferred embodiment, the spring-loaded annulus 13 may comprise an engagement ring 14, a support ring 15, and a plurality of compression nipples 16, as can be seen in FIGS. 1 through 9. The engagement ring 14 corresponds to the section of the spring-loaded annulus 13 that engages the orienting ball 7, while the support ring 15 helps secure the engagement ring 14 to the hemispherical socket 9. The plurality of compression nipples 16 serve as the spring section of the spring-loaded annulus 13. So, the support ring 15 is mounted onto the hemispherical socket 9 and around the cap socket opening 11 to secure the support ring 15 to the hemispherical socket 9. On the other hand, the engagement ring 14 is concentrically mounted to the support ring 15 by the plurality of compression nipples 16. In other words, the engagement ring 14 is separated from the support ring 15 by the plurality of compression nipples 16. When no external force is applied to the orienting ball 7, the orienting ball 7 is pressed against the engagement ring 14 by the plurality of compression nipples 16. If the user presses on the orienting ball 7, the orienting ball 7 pushes the engagement ring 14 against the support ring 15. Once the orienting ball 7 is released, the plurality of compression nipples 16 pushes the orienting ball 7 away from the support ring 15 towards the retainer ring 12. In other embodiments, the plurality of compression nipples 16 can be replaced with springs or other appropriate mechanisms.

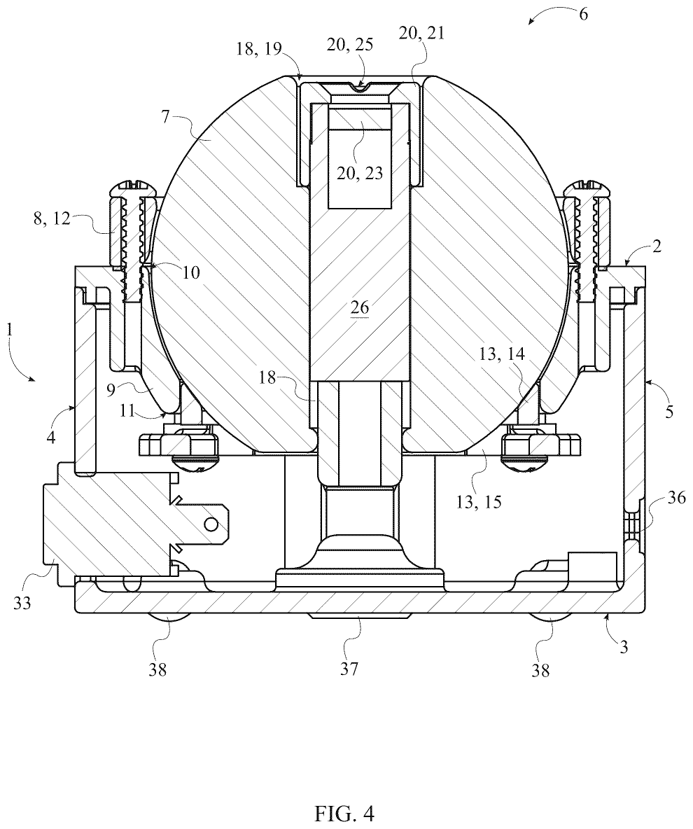

In some embodiments, the rotation of the orienting ball 7 can be limited by a stopper positioned within a proximal open channel end of the diode channel 18, as can be seen in FIG. 4. The proximal open channel end is positioned within the socket setting 8, adjacent to the cap socket opening 11. The stopper protrudes through the cap socket opening 11 when the orienting ball 7 is inserted into the hemispherical socket 9. The overall diameter of the cap socket opening 11 is large enough to enable the limited rotation of the orienting ball 7 when inserted into the hemispherical socket 9. For example, the cap socket opening 11 is large enough to prevent distal open channel end 19 from moving into the hemispherical socket 9 or from being covered by the retainer ring 12. In other embodiments, different mechanisms can be implemented on the tool base 1 and/or the socket setting 8 that allow the limited rotation of the orienting ball 7 within the hemispherical socket 9.

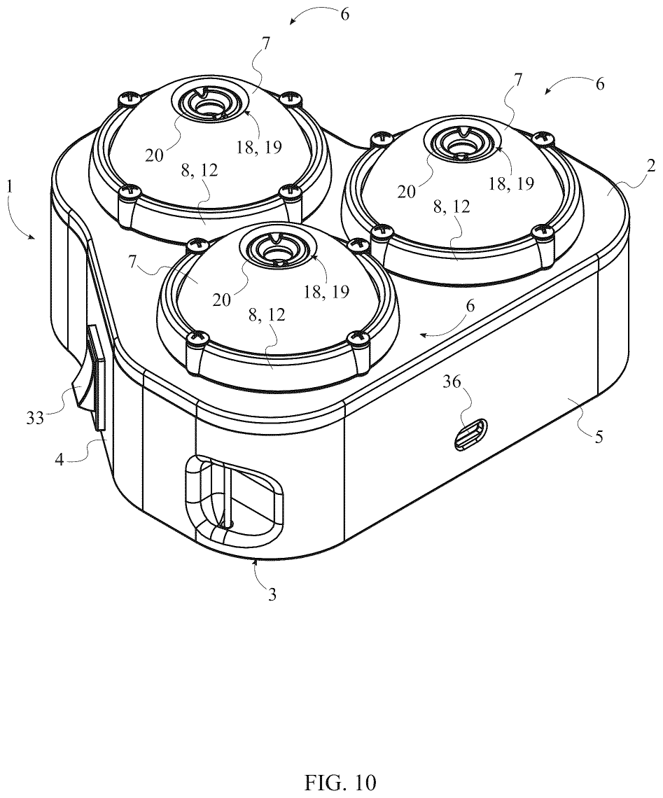

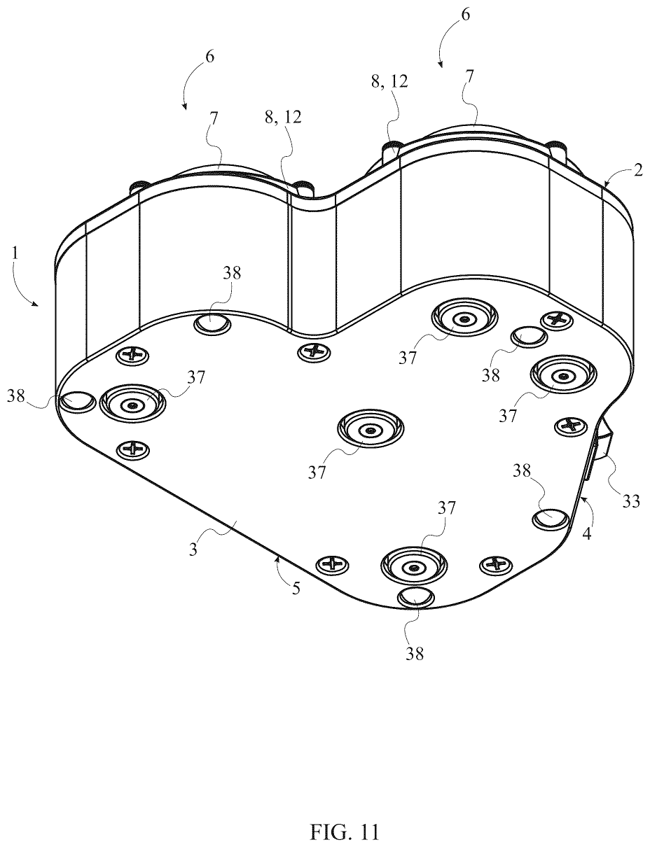

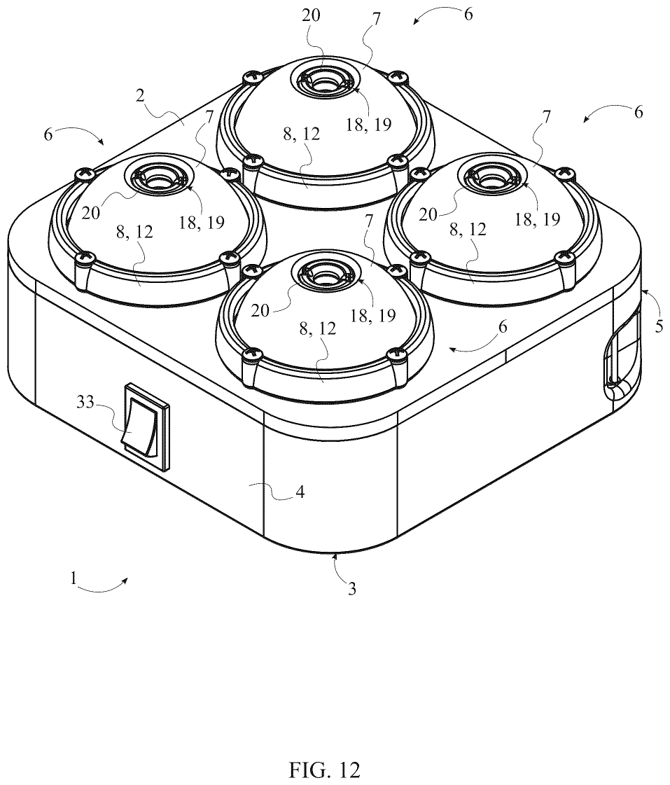

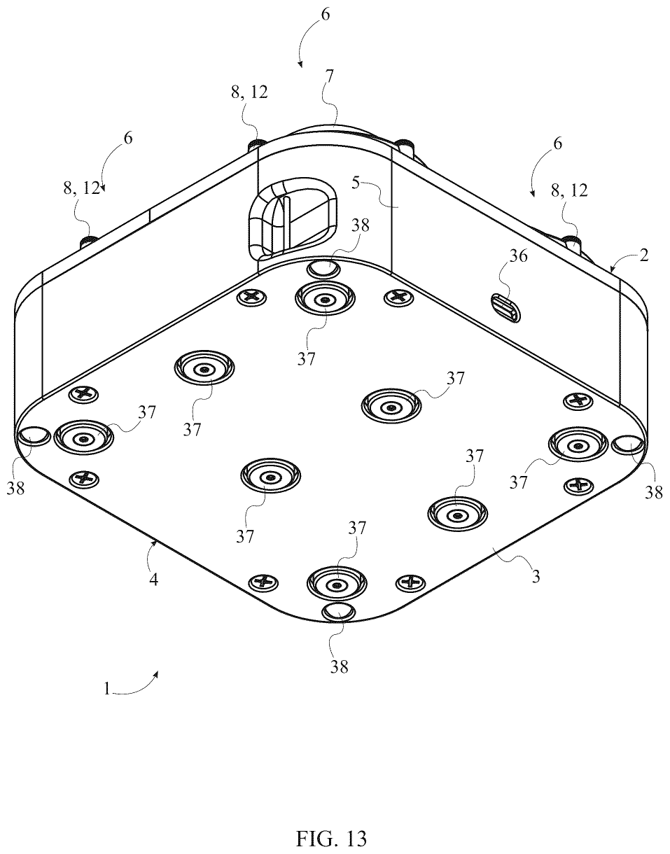

As can be seen in FIGS. 1 through 13, the fixed embodiment of the present invention allows several units of the laser module to be implemented as necessary. A single laser module can be implemented on the tool base 1, with the single laser module centered on the top base face 2. In addition, a pair of laser modules can be implemented on the tool base 1. The pair of laser modules can be distributed along the top base face 2 to evenly position the pair of laser modules on the top base face 2. Several units of the laser module can also be implemented if necessary. For example, three laser modules can be implemented on the tool base 1. To accommodate the laser module trio, the tool base 1 can be shaped into a triangular structure to properly distribute the laser module trio on the top base face 2. Further, four laser modules can be implemented on the tool base 1. To accommodate the four laser modules, the tool base 1 can be enlarged to provide a larger top base face 2 that accommodates the four laser modules. In other embodiments, additional laser modules can be implemented, and the tool base 1 can be redesigned to accommodate the additional laser modules.

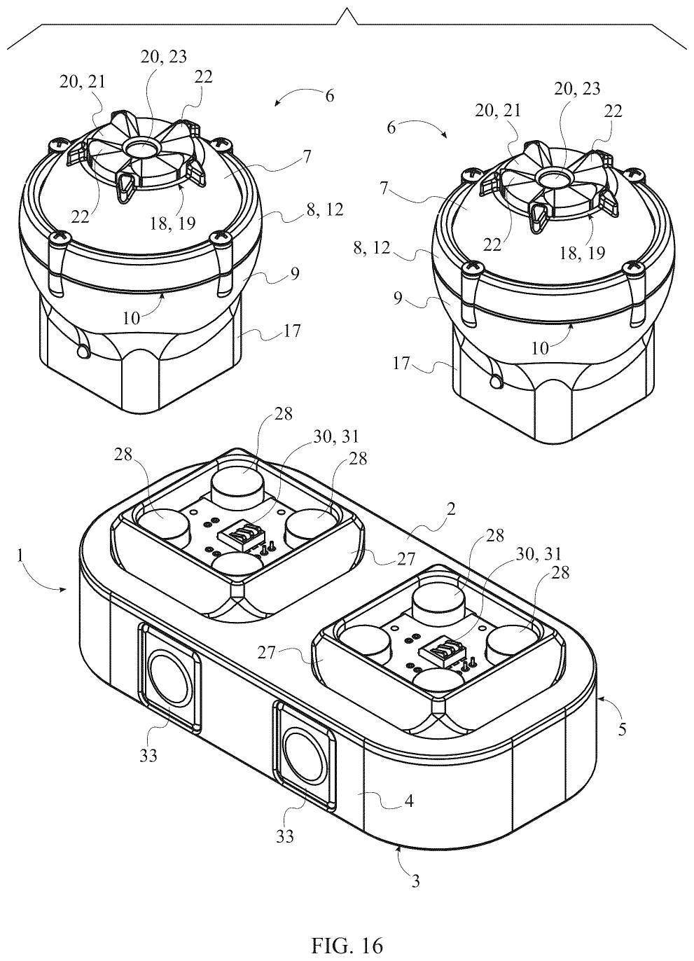

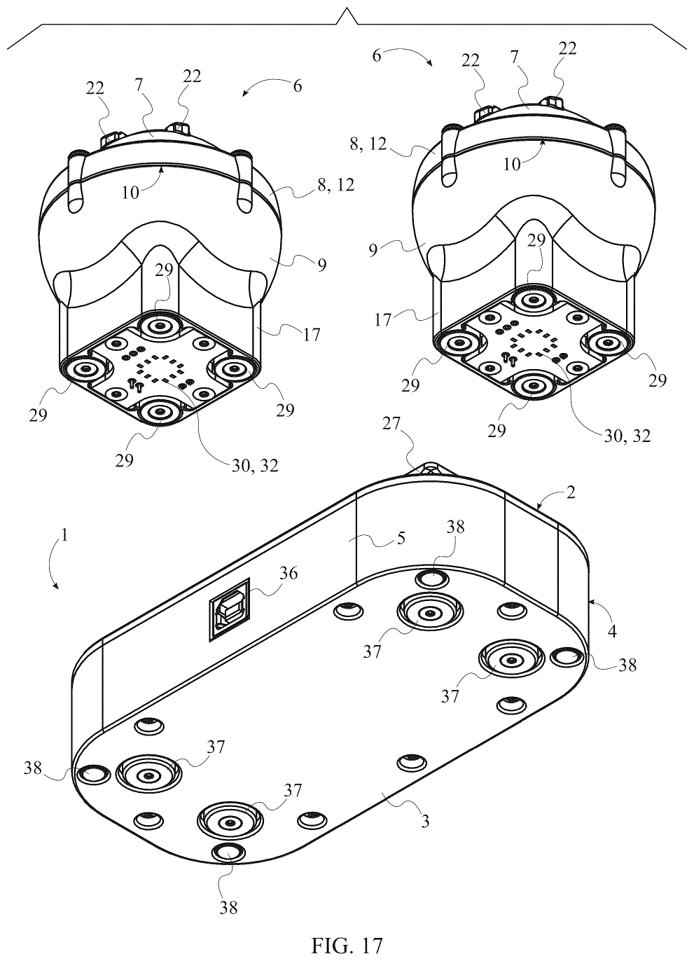

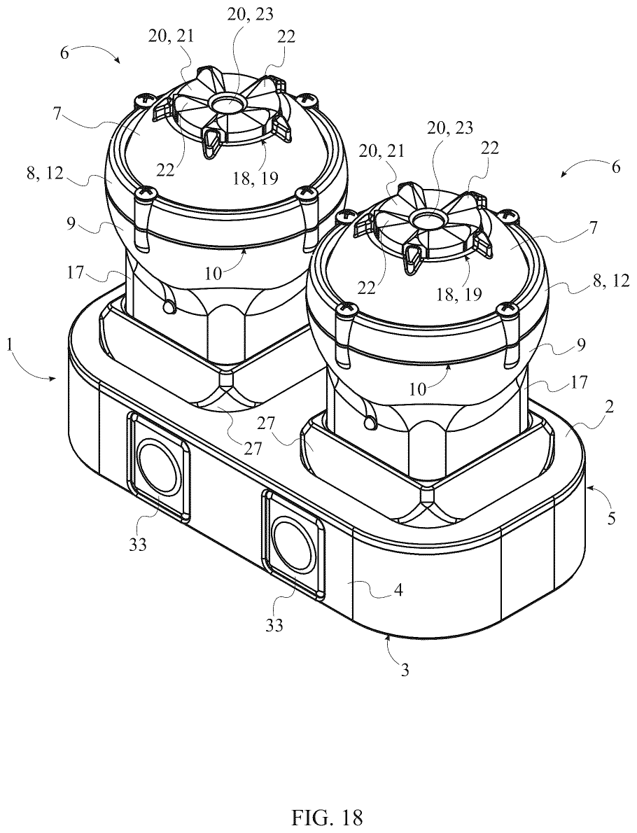

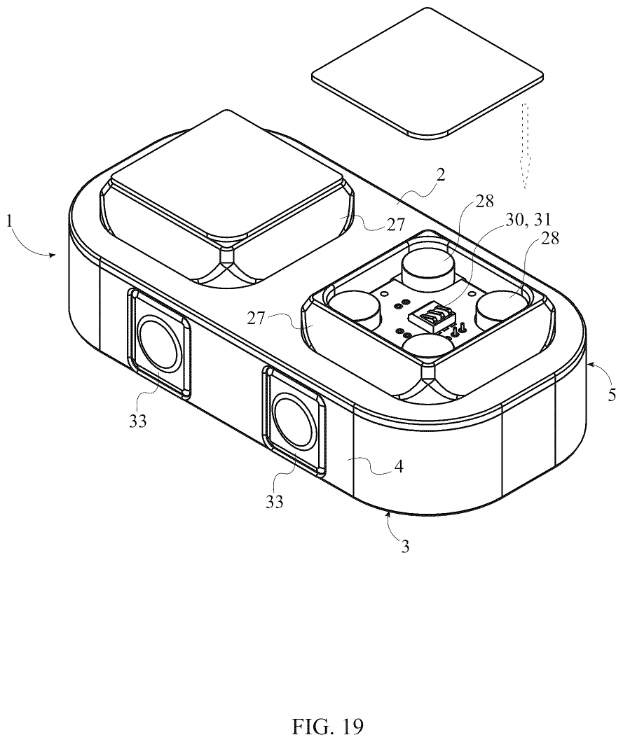

The fixed embodiment of the present invention has many limitations since the laser modules are connected to the tool base 1 in a fixed and cannot be easily replaced. For example, if the user does not want to use the color, pattern, etc., of the emitted light beams, the user would have to use a different unit of the present invention that has a laser module with the desired light beam color, pattern, etc. As can be seen in FIGS. 16 through 19, the present invention can also be provided in a removable embodiment where the at least one laser module 6 is removably attached to the tool base 1. In the removable embodiment, the user can easily replace the at least one laser module 6 with other units of the at least one laser module 6 while using the same tool base 1.

In the removable embodiment of the present invention, the at least one laser module 6 may further comprise a stub socket 27 to facilitates the removable attachment of the at least one laser module 6 to the tool base 1, as can be seen in FIGS. 16 through 19. In addition, the socket setting 8 may comprise a hemispherical socket 9, a retainer ring 12, and an extension stub 17. The hemispherical socket 9 and the retainer ring 12 of the removable embodiment are similar to the hemispherical socket 9 and the retainer ring 12 of the fixed embodiment. However, the hemispherical socket 9 of the removable embodiment forms a single structure with the extension stub 17. The extension stub 17 corresponds to a short protrusion with a cross-sectional area matching the shape and size of the stub socket 27. Further, like the fixed embodiment, the hemispherical socket 9 comprises a diametric socket opening 10 through which the orienting ball 7 can be inserted into the hemispherical socket 9.

As can be seen in FIGS. 16 through 19, to implement the removable embodiment of the at least one laser module 6, the stub socket 27 is integrated through the top base face 2 and into the tool base 1. In other words, a space is formed on the top base face 2 to receive the extension stub 17 when the at least one laser module 6 is attached to the tool base 1. In addition, the hemispherical socket 9 is terminally connected to the extension stub 17, offset from the tool base 1, to form a single structure. Further, the diametrical socket opening is positioned opposite to the extension stub 17 about the hemispherical socket 9 to form the opening necessary for the orienting ball 7 to be inserted into the hemispherical socket 9. In addition, the retainer ring 12 is connected onto the hemispherical socket 9 and around the diametric socket opening 10 to secure the retainer ring 12 and the orienting ball 7 to the hemispherical socket 9. This way, the orienting ball 7 is rollably mounted in between the hemispherical socket 9 and the retainer ring 12 so that the orienting ball 7 can freely rotate within the hemispherical socket 9. Furthermore, to removably attach the at least one laser modular to the tool base 1, the stub socket 27 is engaged by the extension stub 17.

The removable embodiment of the at least one laser module 6 can be secured to the tool base 1 using different mechanisms. As can be seen in FIGS. 16 through 19, in some embodiments, the at least one laser module 6 may further comprise a plurality of proximal magnets 28 and a plurality of distal magnets 29 that facilitate the removable attachment of the extension stub 17 to the stub socket 27. To implement the plurality of proximal magnets 28 and the plurality of distal magnets 29, the plurality of proximal magnets 28 is mounted within the stub socket 27. For example, stub socket 27 can be a rectangular-shaped socket with the plurality of proximal magnets 28 perimetrically distributed within the stub socket 27. In addition, the plurality of proximal magnets 28 is positioned offset from each other to accommodate other components within the stub socket 27.

On the other hand, the plurality of distal magnets 29 is terminally connected to the extension stub 17, opposite the hemispherical socket 9. For example, when the extension stub 17 is shaped as an elongated rectangular stub to match the stub socket 27, the plurality of distal magnets 29 is perimetrically distributed about the terminal end of the extension stub 17 opposite to the hemispherical socket 9. The arrangement of the plurality of distal magnets 29 preferably matches the arrangement of the plurality of proximal magnets 28 to facilitate the engagement to each other. Then, when the extension stub 17 is engaged into the stub socket 27, each of the plurality of distal magnets 29 is magnetically engaged to a corresponding proximal magnet from the plurality of proximal magnets 28. Alternatively, the plurality of proximal magnets 28 can be replaced with a plurality of metal studs, such as carbon steel studs held in with C-clips, that can engage the plurality of distal magnets 29. In other embodiments, different mechanisms can be implemented to facilitate the secure removable attachment of the at least one laser module 6 to the tool base 1.

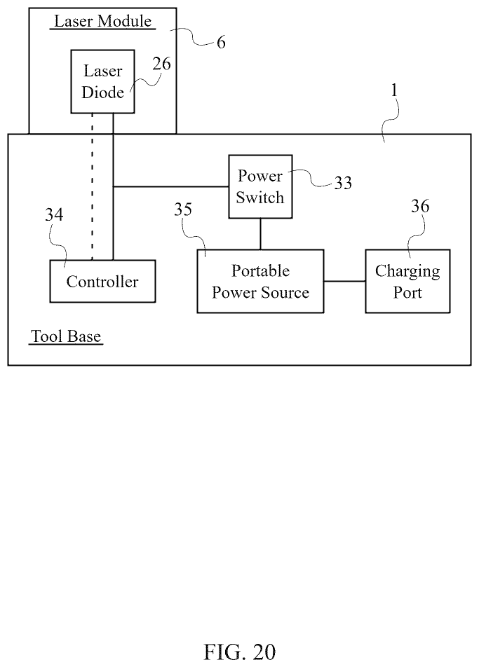

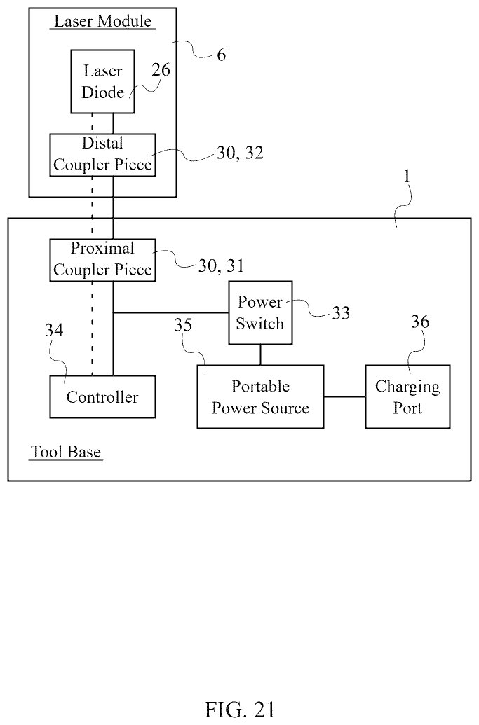

In the fixed embodiment of the present invention, the laser diode 26 within the orienting ball 7 can be directly wired to the controller 34 and the portable power source 35 since the at least one laser module 6 is connected to the tool base 1, as can be seen in FIG. 20. However, in the removable embodiment, the laser diode 26 cannot be directly wired to the controller 34 and the portable power source 35. To address this issue, the at least one laser module 6 may further comprise at least one electronic coupler 30, as can be seen in FIGS. 16 through 19 and 21. The at least one electronic coupler 30 is preferably an omnidirectional electronic coupler with a proximal coupler piece 31 and a distal coupler piece 32 that can be removably coupled to each other. Different types of electronic couplers can be implemented on the socket setting 8 that allow omnidirectional coupling so that the extension stub 17 can be engaged into the stub socket 27 in any direction.

In the preferred embodiment, the at least one electronic coupler 30 can be implemented as follows: the proximal coupler piece 31 is centrally connected within the stub socket 27 so that the proximal coupler piece 31 is not obstructed by the plurality of proximal magnets 28, as can be seen in FIGS. 16 through 19 and 21. The proximal coupler piece 31 can correspond to the female portion of the at least one electronic coupler 30. On the other hand, the distal coupler piece 32 is terminally and centrally connected onto the extension stub 17, opposite the hemispherical socket 9, to match the position of the proximal coupler piece 31 in the stub socket 27. The distal coupler piece 32 can correspond to the male portion of the at least one electronic coupler 30. Further, when the extension stub 17 is engaged into the stub socket 27, the distal coupler piece 32 is engaged into the proximal coupler piece 31. Once coupled, the laser diode 26 is electronically connected to the controller 34 and electrically connected to the portable power source 35 through the laser coupler. This way, the at least one laser module 6 can be removably attached to the tool base 1 in any direction to facilitate the swapping of laser modules as necessary. Further, when the at least one laser module 6 is removed from the tool base 1, the proximal coupler piece 31 can be left exposed to damage. To protect the proximal coupler piece 31 when not in use, the at least one laser module 6 may further comprise a socket cover. The socket cover can be provided as a removable piece of material that matches the shape and size of the stub socket 27.

Similar to the fixed embodiment, the removable embodiment of the present invention also allows several units of the laser module to be implemented as necessary. As can be seen in FIGS. 16 through 19, a pair of stub sockets can be implemented on the tool base 1 to receive a pair of laser modules. The pair of laser modules can be removably attached to either of the pair of stub sockets as necessary. In addition, either of the pair of laser modules can be swapped with other laser modules if desired. Further, several units of the laser module can also be implemented if necessary. For example, four stub sockets can be implemented on the tool base 1 that accommodate four laser modules. Similarly, any of the four laser modules can be swapped with other laser modules if desired. To accommodate the four stub sockets, the tool base 1 can be enlarged to provide a larger top base face 2 that accommodates the four stub sockets. In other embodiments, additional laser modules can be implemented, and the tool base 1 can be redesigned to accommodate the necessary stub sockets.

The present invention can include different features that allow the direct control of the at least one laser module 6 from the tool base 1. In some embodiments, the at least one laser module 6 may further comprise at least one power switch 33 that allows the selective activation of the laser diode 26 in the at least one laser module 6, as can be seen in FIGS. 1 through 21. In addition, the tool base 1 may further comprise a front lateral face 4 that accommodates the at least one power switch 33. To implement the at least one power switch 33, the at least one power switch 33 is integrated into the front lateral face 4. The at least one power switch 33 can be centered on the front lateral face 4 to match the position of the at least one laser module 6 on the tool base 1. Further, the laser diode 26 and the controller 34 are electrically connected to the portable power source 35 through the at least one power switch 33. This way, the user can selectively turn on the present invention using the at least one power switch 33. When a plurality of laser modules are implemented, a plurality of power switches can be implemented. The plurality of power switches is configured to control a corresponding laser module of the plurality of laser modules. This way, the user can selectively turn on each of the plurality of laser modules as necessary.

As previously discussed, the present invention is designed as a portable device that can be deployed on different surfaces to align the desired product. As can be seen in FIGS. 1 through 21, the facilitate the portable operation, the present invention may further comprise a charging port 36. The charging port 36 is designed to enable the recharging of the portable power source 35 using electrical power from an external power source, such as the electric utilities of a building. The design and type of the charging port 36 depends on the charging cable to be used for the present invention. In addition, the tool base 1 may further comprise a rear lateral face 5 to accommodate the charging port 36. The rear lateral face 5 is preferably positioned opposite to the front lateral face 4 across the tool base 1. To implement the charging port 36, the charging port 36 is integrated into the rear lateral face 5. Further, the charging port 36 is electrically connected to the portable power source 35 to enable the transmission of electrical power from the external power source to the portable power source 35. In other embodiments, different recharging mechanisms can be implemented. For example, the portable power source 35 can be implemented as replaceable batteries.

The present invention is designed to be attached to different surfaces where the product needs to be aligned. In some embodiments, to enable the removable attachment of the present invention to a metal surface, the present invention may further comprise a plurality of mounting magnets 37, as can be seen in FIGS. 1 through 19. The plurality of mounting magnets 37 enables the tool base 1 to be removably attached to the target metal surface. To implement the plurality of mounting magnets 37, the plurality of mounting magnets 37 is peripherally distributed around the bottom base face 3. This enables the tool base 1 to be securely attached to the target metal surface. Further, each of the plurality of mounting magnets 37 is mounted onto the bottom base face 3 to secure the plurality of mounting magnets 37 to the tool base 1. In other embodiments, different mounting mechanisms can be implemented to facilitate the removable attachment of the tool base 1 to surfaces of other materials.

As can be seen in FIGS. 1 through 19, to protect the surface when the tool base 1 is removably attached to the target surface, the present invention may further comprise a plurality of mounting legs 38. The plurality of mounting legs 38 can correspond to several rubber protrusions that protects the surface the tool base 1 is attached to. To implement the plurality of mounting legs 38, the plurality of mounting legs 38 is peripherally distributed around the bottom base face 3. This ensures that the entire bottom base face 3 is kept offset to the target surface. The plurality of mounting legs 38 is distributed in such a way that the plurality of mounting legs 38 does not obstruct the plurality of mounting magnets 37. Further, each of the plurality of mounting legs 38 is mounted onto the bottom base face 3 to secure the plurality of mounting legs 38 to the tool base 1.

As previously discussed, the focusing mechanism 20 is designed to help configure the light beams emitted by the laser diode 26. In some embodiments, the focusing mechanism 20 may comprise a focus-adjustment ring 21 and a lens assembly 23, as can be seen in FIGS. 1 through 9. The focus-adjustment ring 21 enables the manual configuration of the lens assembly 23 which modifies the light beams that pass through the lens assembly 23. To implement the focus-adjustment ring 21 and the lens assembly 23, the lens assembly 23 is mounted within the diode channel 18, adjacent to the distal open channel end 19, to secure the lens assembly 23 to the orienting ball 7. In addition, the laser diode 26 is in optical communication with the lens assembly 23 so that the emitted light beams can be modified by the lens assembly 23. Further, the focus-adjustment ring 21 is rotatably mounted around the distal open channel end 19 to secure the focus-adjustment ring 21 to the orienting ball 7. The focus-adjustment ring 21 is also operatively coupled to the lens assembly 23. The focus-adjustment ring 21 is used to focus electromagnetic radiation emitted by the laser diode 26 and through the lens assembly 23. For example, a simple gear mechanism can be implemented to torsionally connect the focus-adjustment ring 21 to the lens assembly 23.

Different mechanisms can be implemented to enable the manual configuration of the focusing mechanism 20 by the user. In one embodiment, the focus-adjustment ring 21 may comprise a plurality of finger protrusions 22 that allows the user to directly configure the focusing mechanism 20, as can be seen in FIG. 16 through 18. To implement the plurality of finger protrusions 22, the plurality of finger protrusions 22 is radially distributed around the focus-adjustment ring 21. The distribution of the plurality of finger protrusions 22 allows the user to use two or more fingers to rotate the focus-adjustment ring 21. Further, each of the plurality of finger protrusions 22 is externally mounted onto the focus-adjustment ring 21 so that the user can access the plurality of finger protrusions 22.

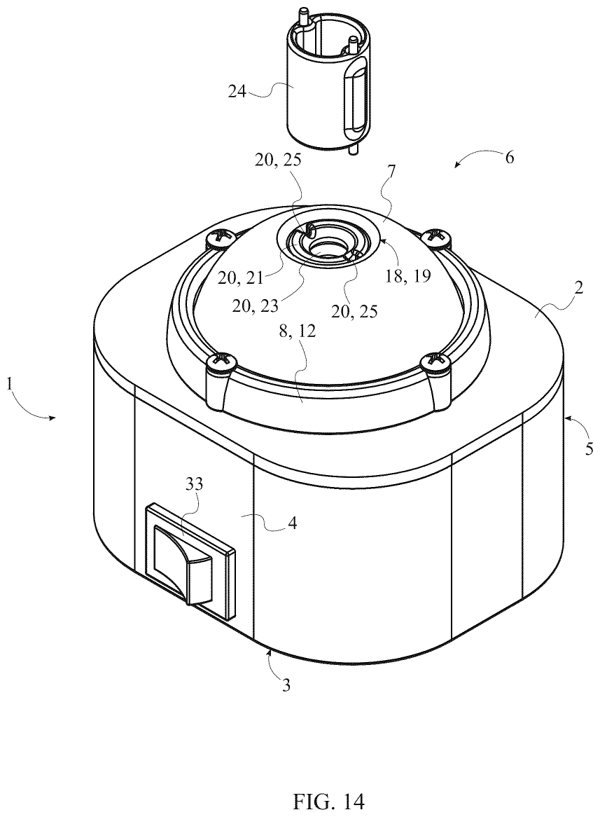

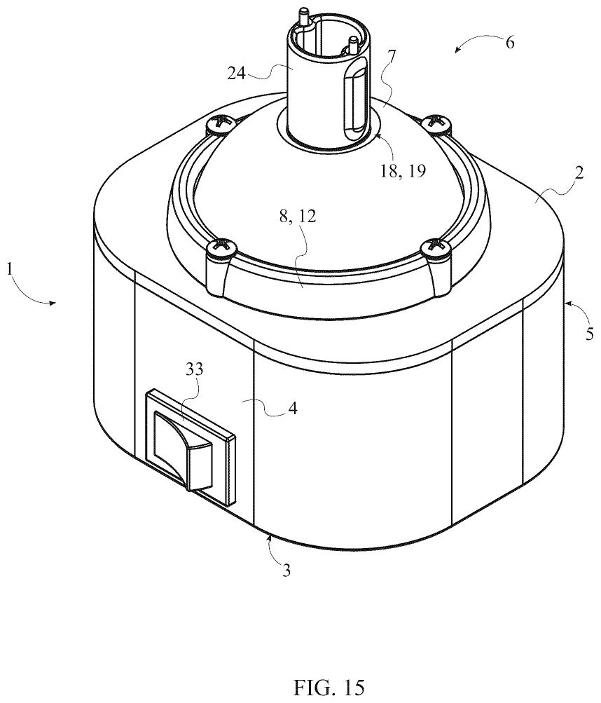

In another embodiment, the focusing mechanism 20 may be indirectly configured using a tool. The focusing mechanism 20 further comprising an adjustment tool 24 and a plurality of tool-engaging orifices 25, as can be seen in FIGS. 14 and 15. The adjustment tool 24 is a portable tool separate from the tool base 1 that user utilizes to engage the focus-adjustment ring 21. The plurality of tool-engaging orifices 25 enables the engagement of the adjustment tool 24 with the focus-adjustment ring 21. For example, the adjustment tool 24 can include several engagement protrusions that engage the plurality of tool-engaging orifices 25. To implement the adjustment tool 24, the plurality of tool-engaging orifices 25 is radially distributed around the focus-adjustment ring 21. The number and distribution of the plurality of tool-engaging orifices 25 matches the number and distribution of the plurality of engagement protrusions on the adjustment tool 24. Further, each of the plurality of tool-engaging orifices 25 traverse into the focus-adjustment ring 21 to form cavities large enough to receive the plurality of engagement protrusions on the adjustment tool 24. Furthermore, the plurality of tool-engaging orifices 25 is selectively engaged by the adjustment tool 24 to enable the user to manually configure the lens assembly 23. In other embodiments, different mechanisms and functional features can be implemented that enable the user to control the operation of the present invention.

Although the invention has been explained in relation to its preferred embodiment, it is to be understood that many other possible modifications and variations can be made without departing from the spirit and scope of the invention.

What is claimed is:

1. A laser alignment tool comprising:
a tool base;
at least one laser module;
a controller;
a portable power source;
the tool base comprising a top base face;
the at least one laser module comprising an orienting ball, a socket setting, a diode channel, a focusing mechanism, and a laser diode;
the diode channel comprising a distal open channel end;
the at least one laser module being positioned adjacent to the top base face;
the orienting ball being pivotably mounted to the tool base by the socket setting;
the diode channel diametrically traversing through the orienting ball;
the distal open channel end being located external to the tool base and the socket setting;
the focusing mechanism being mounted into the distal open channel end;
the laser diode being mounted within the diode channel;
the laser diode being in optical communication with the focusing mechanism;
the controller and the portable power source being mounted within the tool base;
the laser diode being electronically connected to the controller; and
the laser diode and the controller being electrically connected to the portable power source.

2. The laser alignment tool as claimed in claim 1 further comprising:
the socket setting comprising a hemispherical socket and a retainer ring;
the hemispherical socket comprising a diametric socket opening;
the hemispherical socket being integrated into the tool base;
the diametric socket opening being positioned coincident with the top base face;
the retainer ring being connected onto the hemispherical socket and around the diametric socket opening; and
the orienting ball being rollably mounted in between the hemispherical socket and the retainer ring.

3. The laser alignment tool as claimed in claim 2 further comprising:
the socket setting further comprising a spring-loaded annulus;
the hemispherical socket further comprising a cap socket opening;
the diametric socket opening and the cap socket opening being positioned opposite to each other about the hemispherical socket;
the cap socket opening being positioned within the tool base;
the spring-loaded annulus being mounted onto the hemispherical socket and around the cap socket opening; and
the orienting ball being pressed against the spring-loaded annulus.

4. The laser alignment tool as claimed in claim 3 further comprising:
the spring-loaded annulus comprising an engagement ring, a support ring, and a plurality of compression nipples;
the support ring being mounted onto the hemispherical socket and around the cap socket opening;
the engagement ring being concentrically mounted to the support ring by the plurality of compression nipples; and
the orienting ball being pressed against the engagement ring.

5. The laser alignment tool as claimed in claim 1 further comprising:
the at least one laser module further comprising a stub socket;
the socket setting comprising a hemispherical socket, a retainer ring, and an extension stub;
the hemispherical socket comprising a diametric socket opening;
the stub socket being integrated through the top base face and into the tool base;
the stub socket being engaged by the extension stub;
the hemispherical socket being terminally connected to the extension stub, offset from the tool base;
the diametrical socket opening being positioned opposite to the extension stub about the hemispherical socket;
the retainer ring being connected onto the hemispherical socket and around the diametric socket opening; and
the orienting ball being rollably mounted in between the hemispherical socket and the retainer ring.

6. The laser alignment tool as claimed in claim 5 further comprising:
the at least one laser module further comprising a plurality of proximal magnets and a plurality of distal magnets;
the plurality of proximal magnets being mounted within the stub socket;
the plurality of proximal magnets being positioned offset from each other;
the plurality of distal magnets being terminally connected to the extension stub, opposite the hemispherical socket; and
each of the plurality of distal magnets being magnetically engaged to a corresponding proximal magnet from the plurality of proximal magnets.

7. The laser alignment tool as claimed in claim 5 further comprising:
the at least one laser module further comprising at least one electronic coupler;
the at least one electronic coupler comprising a proximal coupler piece and a distal coupler piece;
the proximal coupler piece being centrally connected within the stub socket;
the distal coupler piece being terminally and centrally connected onto the extension stub, opposite the hemispherical socket;
the laser diode being electronically connected to the controller through the laser coupler; and
the laser diode being electrically connected to the portable power source through the laser coupler.

8. The laser alignment tool as claimed in claim 1 further comprising:
the at least one laser module further comprising at least one power switch;
the tool base further comprising a front lateral face;
the at least one power switch being integrated into the front lateral face; and
the laser diode and the controller being electrically connected to the portable power source through the at least one power switch.

9. The laser alignment tool as claimed in claim 1 further comprising:
a charging port;
the tool base further comprising a rear lateral face;
the charging port being integrated into the rear lateral face; and
the charging port being electrically connected to the portable power source.

10. The laser alignment tool as claimed in claim 1 further comprising:
a plurality of mounting magnets;
the tool base further comprising a bottom base face;
the plurality of mounting magnets being peripherally distributed around the bottom base face; and
each of the plurality of mounting magnets being mounted onto the bottom base face.

11. The laser alignment tool as claimed in claim 1 further comprising:
a plurality of mounting legs;
the tool base further comprising a bottom base face;
the plurality of mounting legs being peripherally distributed around the bottom base face; and
each of the plurality of mounting legs being mounted onto the bottom base face.

12. The laser alignment tool as claimed in claim 1 further comprising:
the focusing mechanism comprising a focus-adjustment ring and a lens assembly;
the lens assembly being mounted within the diode channel, adjacent to the distal open channel end;
the laser diode being in optical communication with the lens assembly;
the focus-adjustment ring being rotatably mounted around the distal open channel end; and
the focus-adjustment ring being operatively coupled to the lens assembly, wherein the focus-adjustment ring is used to focus electromagnetic radiation emitted by the laser diode and through the lens assembly.

13. The laser alignment tool as claimed in claim 12 further comprising:
the focus-adjustment ring comprising a plurality of finger protrusions;
the plurality of finger protrusions being radially distributed around the focus-adjustment ring; and
each of the plurality of finger protrusions being externally mounted onto the focus-adjustment ring.

14. The laser alignment tool as claimed in claim 12 further comprising:
the focusing mechanism further comprising an adjustment tool and a plurality of tool-engaging orifices;
the plurality of tool-engaging orifices being radially distributed around the focus-adjustment ring;
each of the plurality of tool-engaging orifices traversing into the focus-adjustment ring; and
the plurality of tool-engaging orifices being selectively engaged by the adjustment tool.
